(19) United States
(12) Patent Application Publication
(10) Pub. No.: US 2023/0124878 A1
(43) Pub. Date: Apr. 20, 2023

(54) Techniques, Systems, and Methods for Visually Organizing Family Relations Using a Mapping Digital Interface

(71) Applicant: Steven Gray, Salt Lake City, UT (US)

(72) Inventor: Steven Gray, Salt Lake City, UT (US)

(21) Appl. No.: 17/967,080

(22) Filed: Oct. 17, 2022

Related U.S. Application Data
(60) Provisional application No. 63/256,614, filed on Oct. 17, 2021.

(51) Int. Cl. G06F 16/9537; G06F 16/9538; G06F 16/9536

(52) U.S. Cl. CPC G06F 16/9537; G06F 16/9538; G06F 16/9536

(57) ABSTRACT

A method of mapping locations of living relatives, including: receiving input from a first living person; identifying, based on at least in part on both the received input and data stored in a database, a second living person that has a family relationship with the first living person; determining a location associated with the second living person; and displaying on a map, based at least in part on the determining, the location associated with the second living person. The identifying may include identifying a first plurality of living persons that includes the second living person that each have a family relationship with the first living person. The determining the location may include determining locations respectively associated with each of the first plurality of living persons. The displaying includes displaying on the map at least some of the particular locations respectively associated with each of the first plurality of living persons.

### CROSS-REFERENCE TO RELATED APPLICATIONS

This application claims priority and benefit to: U.S. Application No. 63/256,614, filed on Oct. 17, 2021, the contents of which are incorporated herein by this reference as though set forth in their entirety.

### BACKGROUND

Available family history mapping systems focus primarily on ancestors. Some such mapping systems map key events in ancestors' lives. For instance, some such systems may show where ancestors were born and where they were buried. Some such systems track the life paths of ancestors, for example, as they travel across oceans, immigrate to different countries, etc.

Such mapping systems generally use simple symbols for designating deceased persons and/or their locations at a given time. For example, some systems may use particular designs to symbolize a gender type (e.g., male or female). Other such systems may show the locations of the ancestors in a maternal line in one color, and show the locations of ancestors in a paternal line in another color. Other systems may designate a location of an ancestor with a headshot photographic image (if available) of the ancestor.

Most family history mapping systems only map the locations of a limited number of generations of ancestors going backward, while a few show more ancestor generations. Most such mapping systems are limited to showing the locations of deceased direct ancestors, while a few might also show deceased children of direct ancestors. There exists a need for improved and more elegant mapping systems relating to families.

### SUMMARY

In one example, a method of mapping locations of living relatives or other persons is described. One method example may include receiving input from a first living person; identifying, based on at least in part on both the received input and data stored in a database, a second living person that has a family relationship with the first living person; determining a location associated with the second living person; and displaying on a map, based at least in part on the determining, the location associated with the second living person.

In one example of the method, the identifying includes identifying a first plurality of living persons that includes the second living person that each have a family relationship with the first living person; and the determining the location includes determining locations respectively associated with each of the first plurality of living persons; and the displaying includes displaying on the map at least some of the particular locations respectively associated with each of the first plurality of living persons.

One example of the method also includes assigning at least one group identifier to each of the first plurality of living persons, where the displaying on the map is based at least in part on the at least one group identifier. Some examples of the method also include selecting, by the user, at least one of the at least one group identifier, where the displaying is based at least in part on the selecting.

In some examples of the method, the family relationship that the second living person has with the first living person includes the first living person and the second living person sharing a first common ancestor.

In some examples, the family relationship that each of the first plurality of living persons has with the first living person includes the first living person and each of the first plurality of living persons sharing at least one common ancestor, and the assigning is based at least in part on each of the first plurality of living persons respectively sharing at least one common ancestor with the first living person. In one example, the first plurality of living persons and the first living person sharing at least one common ancestor further includes each of the first plurality of living persons and the first living person together sharing at least a same first common ancestor. In one example, the assigning is based at least in part on the same first common ancestor.

In one example, the identifying further includes identifying a second plurality of living persons that share at least a same second common ancestor with the first living person, where the second common ancestor is distinct from the first common ancestor; and where the determining the location further includes determining locations respectively associated with each of the second plurality of living persons; and where the displaying further includes displaying on the map at least some of the particular locations respectively associated with each of the second plurality of living persons. In one example, the method also includes determining at least one generational value associated with each of the first plurality of living persons and with each of the second plurality of living persons, where the assigning is based at least in part on the at least one generational value.

In another example, the method includes generating at least one visual identifier, based at least in part on at least one of the at least one generational value, the first common ancestor, or the second common ancestor. In another example of the method, the displaying on the map includes marking the at least some of the particular locations respectively associated with each of the first plurality of living persons or with each of the second plurality of living persons using the generated at least one visual identifier. In one example, a first visual identifier may be associated with the first common ancestor and a second visual identifier may be associated with the second common ancestor, where the first visual identifier is visually distinct from the second visual identifier.

In another example, the method may include generating at least one first visual identifier type based at least in part on the at least one common ancestor, generating at least one second visual identifier type based at least in part on at least one generational value associated with each of the first plurality of living persons. In some such examples, the displaying on the map may further include marking the at least some of the particular locations respectively associated with each of the first plurality of living persons using the generated at least one first visual identifier type and the generated at least one second visual identifier type. In an example the method may include generating a symbol that includes both the generated at least one first visual identifier type and the generated at least one second visual identifier type.

In another example, the method may include determining at least one generational value associated with each of the first plurality of living persons, where the assigning is based at least in part on the determining the least one generational value. In another example, the method may include generating at least one symbol, where each at least one symbol corresponds to each at least one group identifier, and where the displaying on the map further includes marking the at least some of the particular locations respectively associated with each of the first plurality of living persons using the at least one symbol. In an example of the method, each at least one symbol corresponding to each at least one group identifier may be visually distinct from another at least one symbol.

In one example method, the identifying further may include identifying all known living persons that share the first common ancestor with the first living person. In some examples, the determining the location may further include determining who of the all known living persons have respectively associated known locations. In some examples, the displaying may further include displaying on the map the known locations respectively associated with the all known living persons.

In one example of the method, the family relationship that the second living person has with the first living person may include the first living person and the second living person sharing a first common ancestor, In an example, the method may further include identifying, based at least in part on the received input, a third living person that at least one of shares the first common ancestor with the first living person and the second living person or shares a second common ancestor with at least one of the first living person or the second living person. In an example, the method may include determining a location associated with the third living person, and displaying on a map the location associated with the third living person. In an example of the method, the displaying the location associated with the third living person may be based at least in part on the second common ancestor.

In an example, the method may include determining a first generational value associated with the first common ancestor; and determining a second generational value associated with the first common ancestor. In an example of the method, the displaying may be based at least in part on the first generational value and the second generational value.

In an example, the method may also include assigning, based at least in part on at least one of the determined first generational value or the first common ancestor, a first symbol associated with the second living person. In an example, the method may also include assigning, based at least in part on at least one of the determined second generational value or the second common ancestor, a second symbol associated with the third living person. In an example of the method the displaying may also include marking the location associated with the second living person using the assigned first symbol and marking the location associated with the third living person using the assigned third symbol.

In an example of the method, the generational value may be associated with one of a parent generation in relation to the first living person, grandparent generation in relation to the first living person, a great-grandparent generation in relation to the first living person, a great-great grandparent generation in relation to the first living person, a great-great-great grandparent generation in relation to the first living person, and a great-great-great-great grandparent generation in relation to the first living person.

In an example of the method, the first generational value may be distinct from the second generational value, and wherein the assigned first symbol may be based at least in part on the first generational value, and the assigned second symbol may be based at least in part on the second generational value, and the assigned first symbol may be visually distinguishable from the assigned second symbol. In an example of the method, the first common ancestor may be distinct from the second common ancestor, and where the assigned first symbol may be based at least in part on the first common ancestor, and the assigned second symbol may be based at least in part on the second common ancestor, and the assigned first symbol may be visually distinguishable from the assigned second symbol.

In an example of the method, the received input may include location information associated with the first person, and the displaying on the map the location associated with the second living person may be with reference to the location information associated with the first person. In an example of the method, the displaying on the map the location associated with the second living person may include a current place of residence of the second living person. In another example, the determining the location associated with the second living person may be based at least in part on the information contained in the database. In another example, the database may be associated with a family tree.

A first method of visually organizing data using a digital interface is also described. The method may include, in one example, receiving an input from a user, analyzing the received input, determining, based on the analysis, a living person with a family relation to the user, generating a visual characteristic associated with the relation; and displaying the visual characteristic to the user.

In another example, the method may include displaying data associated with the received input. In another example, the displayed data may include less complete data than the received input. In another example of the method, the received input may include a geographical location. In another example, the geographical location may include an address.

Another of the method includes displaying data associated with the received input, where the displayed data includes less complete data than the received input. In another example of the method, the analyzing may include selecting at least one of a state, province, municipality, and county associated with the address, and wherein the displaying data mau include displaying only the selected at least one of a state, province, municipality, and county associated with the address, and hiding the address.

In another example of the method, the displaying may include displaying the visual characteristic on an interactive interface including an image associated with a map. In another example, the visual characteristic may be associated with a location on the map. In another example, the received input may include a generational value, and the visual characteristic may include at least one of a symbol or color associated with the generational value.

In another example of the method, the visual characteristic may include a color associated with the relation. Another example of the method may include recording the received input in a database.

A second method of visually organizing data using a digital interface is also described. The method may include receiving a first input from a first user, receiving a second input from a second user, analyzing the received first input and the received second input, determining, based on the analysis, that the first user and the second user have a family relation, generating a visual characteristic associated with the relation, wherein the generating is based at least in part on the reference frame of the second user; and displaying the visual characteristic to the second user.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein—including their organization and method of operation—together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components—including those having a dash and a second reference label—apply to other similar components. If only the first reference label is used in the specification, the description is applicable to any one of the similar components having the same first reference label irrespective of the second reference label.

FIG. 1 shows a mapping system for mapping locations of relatives in accordance with various aspects of this disclosure;

FIG. 2 is a flow chart illustrating an example of a method relating to mapping locations of living relatives, in accordance with various aspects of this disclosure;

FIG. 3A is a flow chart illustrating another example of a method relating to mapping locations of living relatives, in accordance with various aspects of this disclosure;

FIG. 3B shows a GUI or a part of GUI related to a method or system of mapping locations of living relatives, in accordance with various aspects of this disclosure;

FIG. 3C shows a GUI or a part of GUI related to a method or system of mapping locations of living relatives, in accordance with various aspects of this disclosure.

FIG. 4 is a flow chart illustrating an example of a method relating to visually organizing data using a digital interface, in accordance with various aspects of this disclosure;

FIG. 5 is a flow chart illustrating another example of a method relating to visually organizing data using a digital interface, in accordance with various aspects of this disclosure;

### DETAILED DESCRIPTION

Everyone is related to someone, whether they know it or not. Even when people generally know some of their relatives, as time passes and life circumstances change, they sadly may often lose track of such relatives, including their whereabouts. For example, people may have their own children, who may eventually marry, and they (as well as their children) may not even be cognizant of the details of the lives of their relatives' children or their spouses (if they are aware of them at all). Relatedly, people often do not know the physical locations of their relatives, including their places of domicile. In some cases, people can live in substantial proximity without ever realizing it, or letting years go by before finally discovering it.

Relatedly, even people that know certain relatives relatively well, might not know when or to where those relatives move or travel to other locations. For example, two sets of relatives may travel to the same place and may never realize it or meet up unless by a stroke of good fortune they cross each other's paths.

Similarly, two sets of relatives may not know each other at all, let alone know that they are even related. One set may travel to the same geographical another where the other set resides, and may never know it.

Presently available social media maps often lack on architecture that is family-based. On the other hand, online family history maps focus primarily on “history,” and often do not include the locations of living persons, such as living relatives—at least not to a desirable degree.

The result is that relatives often miss the opportunity of knowing each other better, or spending more time with one another. This is unfortunate, as a family member could benefit from the friendships, joyful reunions, and/or acts of service, of relatives.

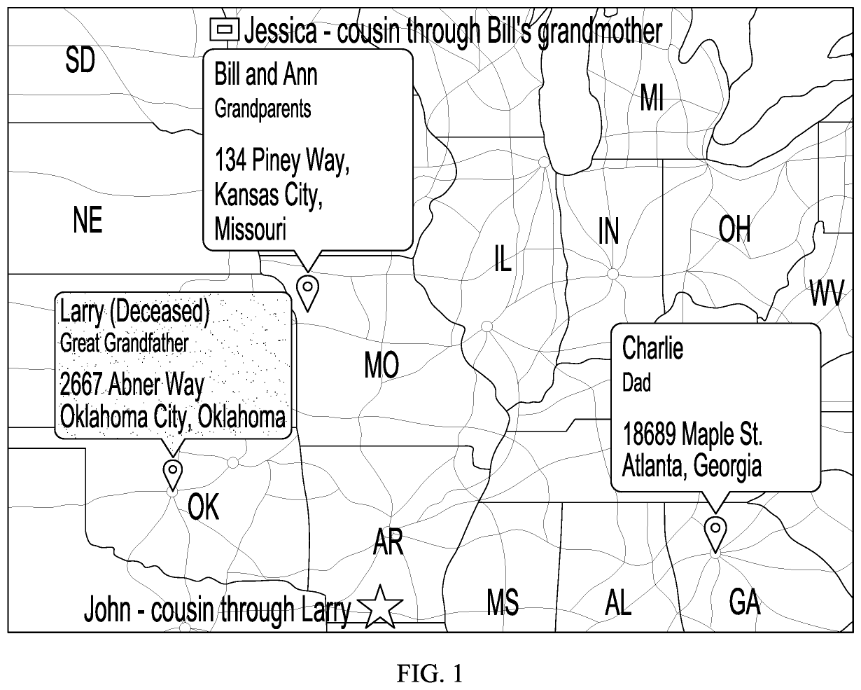

FIG. 1 shows a mapping system for mapping locations of relatives in accordance with various aspects of this disclosure.

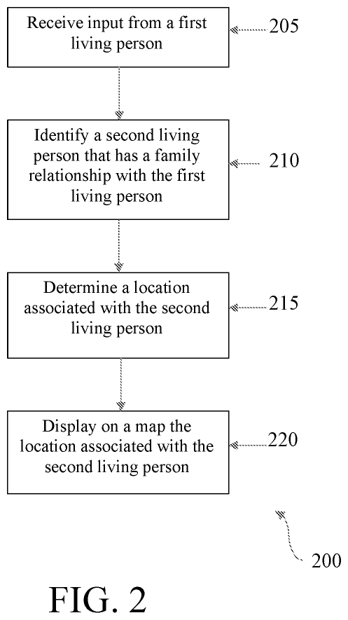

FIG. 2 shows a flow chart 200 illustrating an example of a method relating to mapping locations of living relatives, in accordance with various aspects of this disclosure. At block 205, the method example may include the step of receiving input from a first living person. In some examples, the input may include information related to genealogy or more generally to family relationships. For instance, the input may include the names or other identifying information of living persons to whom the first living person is related. For instance, the input may include data related to a sibling, a parent, a cousin, an aunt or uncle, a grandparent, etc. In addition, the input may include identifying information of people with whom the first living person is related, albeit not by blood, such as an adopted or step parent, sibling, aunt or uncle, grandparent, etc.

In addition or alternatively, the input may include the names or other identifying information of deceased persons to whom the first living person is related. For instance, the input may include data related to a deceased grandparent, great-grandparent, aunt, uncle, great aunt, great uncle, sibling, cousin, etc. In addition, the input may include identifying information of deceased person with whom the first living person is related, albeit not by blood. In some examples, the input may include a data file that may be imported by the first living person, or such an import may be approved, initiated, or used by the first living person.

At block 210, the method example may include of the step of identifying a second living person that has a family relationship with the first living person. Such a second living person could be a sibling, a child, a parent, a cousin, an aunt or uncle, a grandparent, etc., of the first living person. Such a second living person could also have a more distant family relationship with the first living person. In some examples, such identifying may be based on at least in part on both the received input and data stored in a database. In some examples of the method, the family relationship that the second living person has with the first living person may include the first living person and the second living person sharing a first common ancestor.

Such identifying may occur by analyzing data associated with the second living person. The data could be from an online user profile entered in a database or otherwise completed by the second living person or by a relative or friend of the second living person or by someone else (such as the first living person). The identifying may also occur by finding or recognizing a common ancestor shared by both the first living person and by the second living person. In addition, or alternatively, the first living person and the second living person may not share a common ancestor but nevertheless have a family relationship through marriage, including as in-laws, or through a step-grandparent, or through any number of other ways.

The identifying may also include identifying more than one way the first and second person are related or have a family relationship. For example, the first and second living persons may share more than one common ancestor (or a pair of ancestors that were, for example, married) from different family lines, and such multiple common ancestors (or ancestor pairs) may be identified. Similarly, more than one family relationship may be identified between the first living person and the second living person.

At block 215, the method example may include the step of determining a location associated with the second living person. In some examples, the determining may include analyzing information in a user profile of the second living person, left by the second living person or by another person knowledgeable of the second living person's whereabouts. For example, the second living person may have completed a user profile by leaving or inputting a town or address of residence. Or the second living person may leave her/his normal place of residence temporarily and may accordingly update the location information.

In other embodiments, the second living person may grant access to an automated location tracking system, so that the location of the second living person may be updated automatically without requiring additional actions on the part of the second living person.

At block 220, the method example may include the step of displaying on a map the location associated with the second living person. In some examples such displaying may be based at least in part on the determining step of block 215. For example, a system may analyze an address for (and potentially left by) the second living person, and match coordinates for the address on an online map (which may in some examples involve a geolocation mapping system). In some examples, the displaying may involve using an icon associated with characteristics of the second living person or may indicate or refer to some aspect of the relationship between the second living person and the first living person.

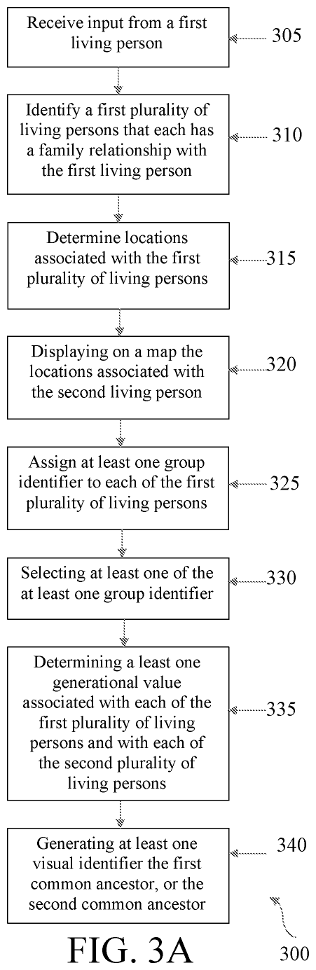

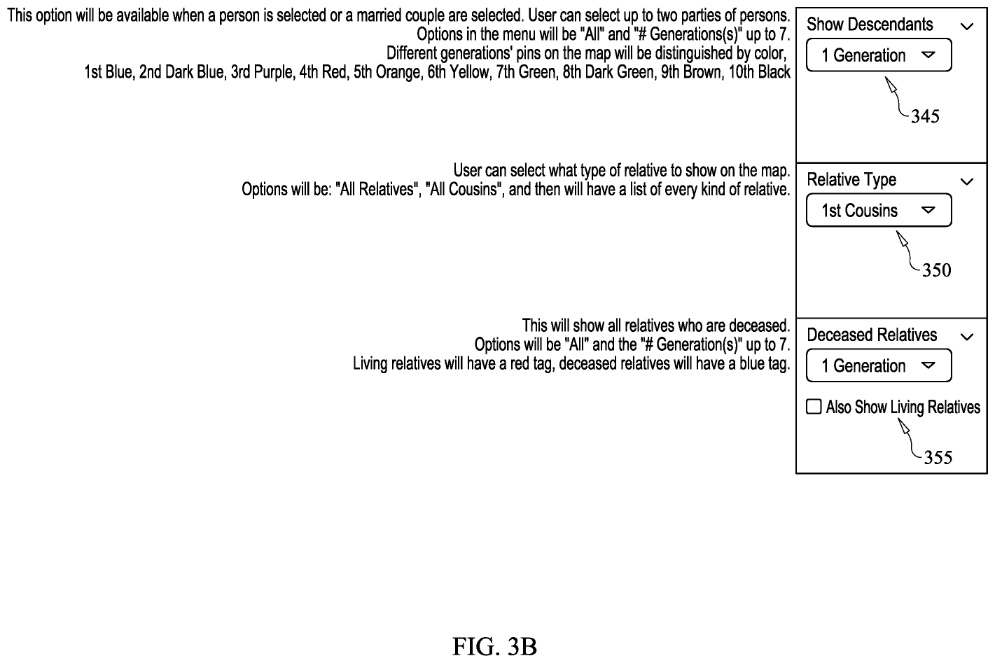

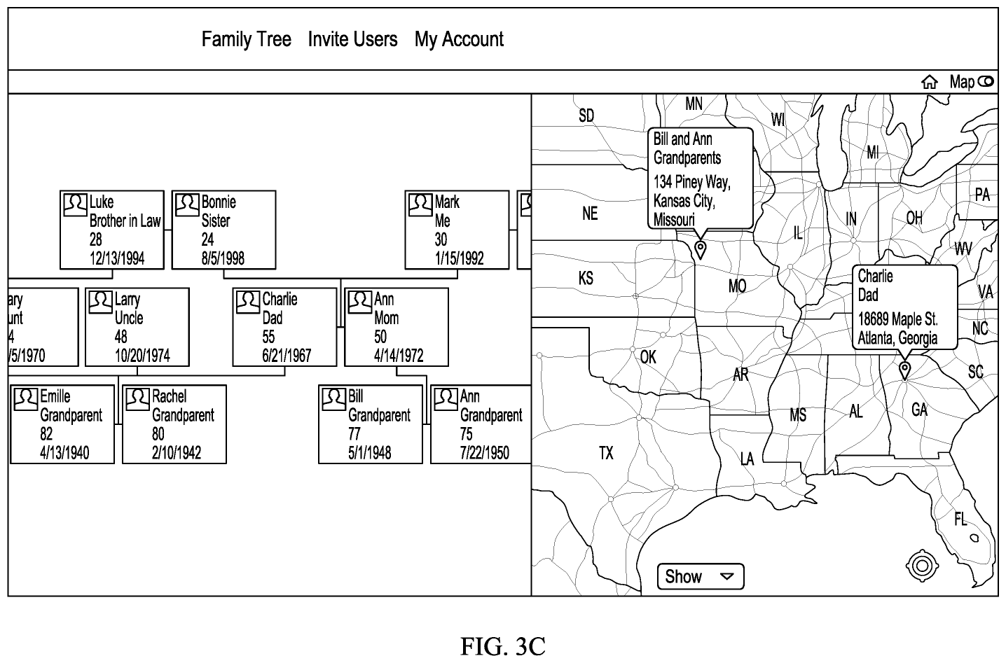

FIG. 3A is a flow chart 300 illustrating another example of a method relating to mapping locations of living relatives, in accordance with various aspects of this disclosure. The steps shown at blocks 305, 310, 315, and 320, may be similar in some aspects to the steps shown in FIG. 2 at blocks 205, 210, 215, and 220.

In some examples of the method, the step of identifying at block 310 may include identifying a first plurality of living persons. In some examples, each person of the first plurality of living persons may have a family relationship with the first living person.

In some examples, the family relationship that each of the first plurality of living persons has with the first living person may include the first living person and each of the first plurality of living persons sharing at least one common ancestor. On the other hand, in some examples, the common ancestors that each of the first plurality of living persons share with the first living person may be different for one or more of each of the first plurality of living persons. For example, in an example, one of the first plurality of living persons and the first living person may share Jane and John Smith as grandparents, while another of the first plurality of living persons and the first living person may share Joachim and Marcela Silveira as great grandparents. And in some examples, the common ancestors that each of the first plurality of living persons share with the first living person may be the same ancestor or pair of ancestors. Stated differently, in one example, the first plurality of living persons and the first living person sharing at least one common ancestor may further include each one of the first plurality of living persons and the first living person together sharing at least a same first common ancestor. In some examples, the first plurality of living persons may include the second living person.

In one example, the identifying step at block 310 may also include identifying a second plurality of living persons that share at least a same second common ancestor with the first living person. In some such examples, the first plurality of living persons may share a same at least one common ancestor with the first living persons. In some examples, the second common ancestor may be distinct from the first common ancestor.

In some examples of the method, the step of determining the location at block 315 may include determining locations respectively associated with each of the first plurality of living persons. In some examples of the method, the step of determining locations at block 315 may include determining locations respectively associated with each of the second plurality of living persons.

In some examples of the method, the step at block 320 of displaying on a map a location at block 320 may include displaying on the map at least some of the particular locations respectively associated with each of the first plurality of living persons. In one example of the method, the step of displaying at block 320 may further include displaying on the map at least some of the particular locations respectively associated with each of the second plurality of living persons.

In some examples, the displaying the locations of both the first plurality of living persons and of the second plurality of living persons may include visually distinguishing between the two groups of locations, for instance, with different styles of icons associated with the locations (as further described elsewhere in this section). Some examples of the method may include identifying additional (e.g., third, fourth, fifth, etc.) pluralities of living persons, with each plurality respectively sharing a different common ancestor with the first living person. And the displaying, in some such examples, may include visually distinguishing between the locations of the different pluralities of living persons.

Some examples may include displaying the locations of different groups of persons, or pluralities of persons, which groups may respectively share common ancestors with the first living person, which groups or pluralities may include both living and deceased persons, or just deceased persons. In some such examples, the displaying includes visually distinguishing not only between the groups, but also between living and deceased person within each group, or between living and deceased person generally (across all groups) (see for example, the dropdown menu 355 of FIG. 3B). In some examples, such visual distinguishing may be accomplished with icons having more than one potential property. For instance, some such icon properties may include color (e.g., blue, yellow, green, etc.), shape (e.g., circle, triangle, rectangle, etc.), size (e.g., small, large, medium, etc.), design (e.g., smiley face, triquetra, flower, animal, a flag, a coat of arms, a family crest, heart, kamon, Lares, family circle, rosette, a dragon/phoenix, Adinkra symbol, hearth, rattle, kitchen stove, heraldry, mon, inverted red triangle, a run such as Othala, a khadga/khanda, a bird like a peacock, a tree, etc.), or letters or characters.

In some examples of the method, the displaying may involve showing the locations or groups of living persons that respectively share at least one common ancestor with the first living person, and then simultaneously displaying on the same map the locations of potentially or likely other groups (or pluralities) of living persons that respectively share at least one common ancestor with another living person. In this matter, the locations of respective relatives of two different people (which two people may have a relationship such as a friendship or who may be spouses) may be compared.

Similarly, in examples of the method where such groups include not just living persons, but also deceased persons (or even only include deceased person), such as deceased ancestors and/or siblings of ancestors, the ability of two separate people to compare the locations of such relatives may reveal some interesting observations. For example, two (or more) persons may discover in just the amount of time it takes to look at a map that they have ancestors from similar parts of the world, or even from the same villages. Some method examples involving deceased person may also include visually distinguishing locations based on time period when such persons lived. Thus, two (or more) persons may also discover by looking at a map that their ancestors lived in a same location at or around the same time.

Some examples of the method involving simultaneously displaying the relatives of two persons on a same map may include determining if the two persons share a common relative (e.g., a living relative) and visually highlighting such persons on the map.

Some examples of the method or system may feature a graphical user interface that not only shows the map, but also shows a summary or key of some of the data that can be summarized from the map, and/or options that a user may select to be shown in the map. In some embodiments, the GUI may include a split screen between the map and the summary and/or control screen (which is some examples may be or resemble a family tree), as shown in FIG. 3C, in accordance with various aspects of this disclosure.

In addition, at block 325, the method example may include the step of assigning at least one group identifier to each of the first plurality of living persons. In some examples, the assigning may be based at least in part on each of the first plurality of living persons respectively sharing at least one common ancestor with the first living person (but not necessarily the same common ancestor for all persons). In one example, the assigning may be based at least in part on the same first common ancestor. In some embodiments, the group identifier may indicate that the first plurality of living persons all pertain to a particular group sharing a common characteristic. In some examples, the group identifier may indicate that the first plurality of living persons share one or more common ancestors. In some examples of the step at block 320, the displaying on the map may be based at least in part on the at least one group identifier. In some examples, the group identifier may refer to all cousins, and/or second cousin, and/or third cousins, etc., and/or such cousins once removed, twice removed, thrice removed, etc. FIG. 3B shows a GUI (or part of a GUI) that illustrates some potential features for carrying out some of these or related features, in accordance with various aspects of this disclosure. For example, FIG. 3B shows a group identifier example called a “Relative Type” that allows selection (through a dropdown menu) of displaying locations of first cousins, etc., on the map.

At block 330, the method example may include the step of selecting at least one of the at least one group identifier. In some examples, such selecting may be by the user. In some examples of the step at block 320, the displaying on the map may be based at least in part on the selecting. For example, the user may select showing the living descendants of a particular ancestor and then the locations of such persons may be displayed on the map.

In addition, at block 335, the method example may include the step of determining at least one generational value. In some examples, the generational value may be considered from the perspective of a particular ancestors. For instance, the children, grandchildren, great-grandchildren, etc., of a particular ancestor may have a respective generational value of 1, 2, 3, etc. An example of a drop-down menu feature 345 allowing a user to select such generation values is illustrated at FIG. 3B.

In some examples, the generational value may be considered from the perspective of the user. For instance, all children of the user may have a generational value of 0, siblings may have a generational value of 1, parents may have a generational value of 2, grandparents may have a generational value of 3, etc. In addition, more distant relatives may also be given the same or a different generational value; for example, children of siblings and cousins may also have a generational value of 0, cousins may have a generational value of 1, aunts and uncles may have a generational value of 2, and great aunts and uncles more have a generational value of 3, etc. In some examples, such generational values may extend almost infinitely outward.

In some examples, the at least one generational value may be associated with each of the first plurality of living persons and with each of the second plurality of living persons. In some examples, there may be at least one different generational value for each of the pluralities of living persons. In some examples, the step of assigning at block 325 may be based at least in part on the at least one generational value.

In addition, at block 340, the method example may include the step of generating at least one visual identifier, based at least in part on at least one of the at least one generational value, the first common ancestor, or the second common ancestor. In another example of the method, the step of displaying on the map at step 320 may include marking the at least some of the particular locations respectively associated with each of the first plurality of living persons or with each of the second plurality of living persons using the generated at least one visual identifier. In one example, a first visual identifier may be associated with the first common ancestor and a second visual identifier may be associated with the second common ancestor. In some examples, the first visual identifier may be visually distinct from the second visual identifier.

Another example of the method, where the step of generating at least one first visual identifier type is based at least in part on the at least one common ancestor, may include a step of generating at least one second visual identifier type based at least in part on at least one generational value associated with each of the first plurality of living persons. In some such examples, the step at block 320 of displaying on the map may further include marking the at least some of the particular locations respectively associated with each of the first plurality of living persons using the generated at least one first visual identifier type and the generated at least one second visual identifier type. In an example, the method may include the step of generating a symbol. In some embodiments, such a symbol may include the generated at least one first visual identifier type, and in some examples may include the generated at least one second visual identifier type, or both. For instance, in some embodiments a symbol or icon may have one or more of a color type, a size, a shape, and/or a design type, etc. In one embodiment, the size of a symbol or icon may change based on how closely related a living person of one of the plurality of living persons is to the first living person (i.e., the size may correspond to “relation distance”).

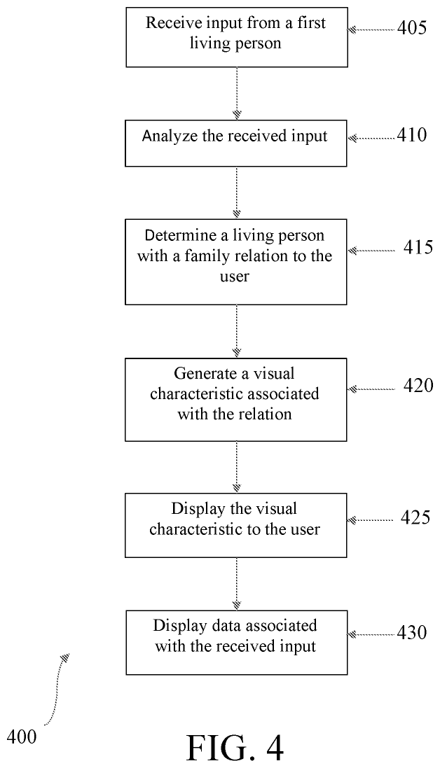

FIG. 4 is a flow chart 400 illustrating an example of a method relating to visually organizing data using a digital interface, in accordance with various aspects of this disclosure. Some examples of the method may include at the block of 405 the step of receiving an input from a user. In some aspects, the step at block 405 may be similar to the steps at blocks 205 and 305 described above.

Some examples of the method may include at the block of 410 the step of analyzing the received input. Analyzing the received input may in some examples happen automatically by one or more algorithms. For instance, based on particular input from the user, certain conclusions may be reached regarding the relatives (whether living or deceased) of the user. In another example of the method, the analyzing may include selecting at least one of a state, province, municipality, and county associated with the address.

Some examples of the method may include at the block of 415 the step of determining a living person with a family relation to the user. In some examples, such determining at block 415 may be based at least in part on the analysis of block 410. As mentioned above, a family relation may but need not refer to sharing a common direct ancestor. For instance, the user at block 410 may input a GEDCOM file that shows that the user has a particular great-great grandparent. The determining may include identifying (by way of example) that the spouse of that great-great grandparent has a sibling with a great-great grandchild, with an adopted child, who because the step parent of a child who is living, and who may be the determined living person.

Some examples of the method may include at the block of 420 the step of generating a visual characteristic associated with the relation.

Some examples of the method may include at the block of 425 the step of displaying the visual characteristic to the user. In another example of the method, the displaying at block 425 may include displaying the visual characteristic on an interactive interface including an image associated with a map.

In another example, the visual characteristic may be associated with a location on the map. In another example, the received input may include or be associated with a generational value, and the visual characteristic may include at least one of a symbol or color associated with the generational value.

In another example of the method, the visual characteristic may include a color associated with the relation. In accordance with other aspects of this disclosure, such a relation need not refer strictly to blood relations. Thus, the visual characteristic may also be associated with the locations of non-blood relatives (e.g., spouses of cousins, etc.) shown on a map. Another example of the method may include recording the received input in a database.

In another example, the method may include, at block 430, the step of displaying data associated with the received input. In another example, the displayed data may include less complete data than the received input. In another example of the method, the received input may include a geographical location. In another example, the geographical location may include an address. In another example, the displaying data may include displaying only the selected at least one of a state, province, municipality, and county associated with the address, and hiding the address.

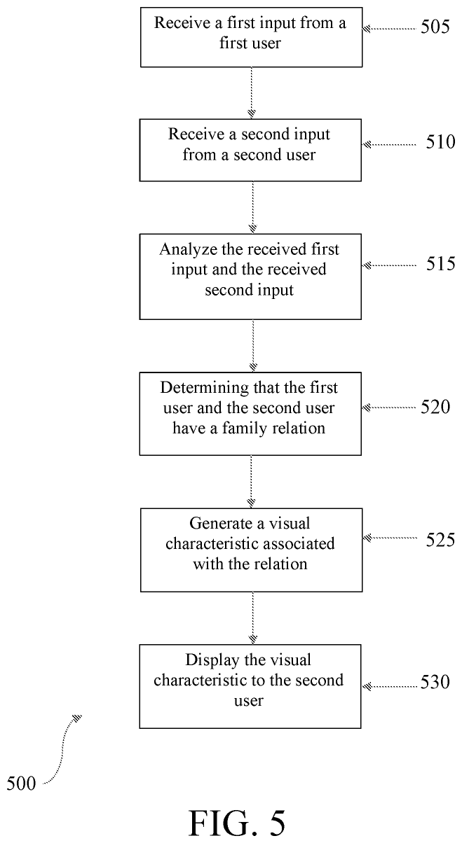

FIG. 5 is a flow chart 500 illustrating another example of a method relating to visually organizing data using a digital interface, in accordance with various aspects of this disclosure. The method may include the step of, at block 505, receiving a first input from a first user (which may be similar in some aspects to the steps at blocks 205, 305, and 405 above. The method may also include the step of, at block 510, receiving a second input from a second user.

The method may include the step of, at block 515, analyzing the received first input and the received second input. The method may also include the step of, at block 520, determining, based on the analysis, that the first user and the second user have a family relation.

The method may include the step of, at block 525, generating a visual characteristic associated with the relation. In some examples, the generating may be based at least in part on the reference frame of the second user.

The method may include the step of, at block 530, displaying the visual characteristic to the second user and/or to the first user.

In one example method, the identifying further may include identifying all known living persons that share the first common ancestor with the first living person. In some examples, the determining the location may further include determining who of the all known living persons have respectively associated known locations. In some examples, the displaying may further include displaying on the map the known locations respectively associated with the all known living persons.

In one example of the method, the family relationship that the second living person has with the first living person may include the first living person and the second living person sharing a first common ancestor, In an example, the method may further include identifying, based at least in part on the received input, a third living person that at least one of shares the first common ancestor with the first living person and the second living person or shares a second common ancestor with at least one of the first living person or the second living person. In an example, the method may include determining a location associated with the third living person, and displaying on a map the location associated with the third living person. In an example of the method, the displaying the location associated with the third living person may be based at least in part on the second common ancestor.

In an example, the method may include determining a first generational value associated with the first common ancestor; and determining a second generational value associated with the first common ancestor. In an example of the method, the displaying may be based at least in part on the first generational value and the second generational value.

In an example, the method may also include assigning, based at least in part on at least one of the determined first generational value or the first common ancestor, a first symbol associated with the second living person. In an example, the method may also include assigning, based at least in part on at least one of the determined second generational value or the second common ancestor, a second symbol associated with the third living person. In an example of the method the displaying may also include marking the location associated with the second living person using the assigned first symbol and marking the location associated with the third living person using the assigned third symbol.

In an example of the method, the generational value may be associated with one of a parent generation in relation to the first living person, grandparent generation in relation to the first living person, a great-grandparent generation in relation to the first living person, a great-great grandparent generation in relation to the first living person, a great-great-great grandparent generation in relation to the first living person, and a great-great-great-great grandparent generation in relation to the first living person.

In an example of the method, the first generational value may be distinct from the second generational value, and wherein the assigned first symbol may be based at least in part on the first generational value, and the assigned second symbol may be based at least in part on the second generational value, and the assigned first symbol may be visually distinguishable from the assigned second symbol. In an example of the method, the first common ancestor may be distinct from the second common ancestor, and where the assigned first symbol may be based at least in part on the first common ancestor, and the assigned second symbol may be based at least in part on the second common ancestor, and the assigned first symbol may be visually distinguishable from the assigned second symbol.

In an example of the method, the received input may include location information associated with the first person, and the displaying on the map the location associated with the second living person may be with reference to the location information associated with the first person. In an example of the method, the displaying on the map the location associated with the second living person may include a current place of residence of the second living person. In another example, the determining the location associated with the second living person may be based at least in part on the information contained in the database. In another example, the database may be associated with a family tree.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, e.g., a combination of a DSP and a microprocessor, multiple microprocessors, one or more microprocessors in conjunction with a DSP core, and/or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Some aspects of the disclosure may involve computer-readable media. Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A method of mapping locations of living relatives, the method comprising:
receiving input from a first living person;
identifying, based on at least in part on both the received input and data stored in a database, a second living person that has a family relationship with the first living person;
determining a location associated with the second living person; and
displaying on a map, based at least in part on the determining, the location associated with the second living person.

2. The method of claim 1, wherein the identifying further comprises identifying a first plurality of living persons that includes the second living person that each have a family relationship with the first living person;
and wherein the determining the location further comprises determining locations respectively associated with each of the first plurality of living persons;
and wherein the displaying further comprises displaying on the map at least some of the particular locations respectively associated with each of the first plurality of living persons.

3. The method of claim 2, further comprising:
assigning at least one group identifier to each of the first plurality of living persons;
wherein the displaying on the map is based at least in part on the at least one group identifier.

4. The method of claim 3, further comprising:
selecting, by the user, at least one of the at least one group identifier;
wherein, the displaying is based at least in part on the selecting.

5. The method of claim 3, wherein the family relationship that the second living person has with the first living person comprises the first living person and the second living person sharing a first common ancestor.

6. The method of claim 5, wherein the family relationship that each of the first plurality of living persons has with the first living person comprises the first living person and each of the first plurality of living persons sharing at least one common ancestor, and wherein the assigning is based at least in part on each of the first plurality of living persons respectively sharing at least one common ancestor with the first living person.

7. The method of claim 6, wherein the first plurality of living persons and the first living person sharing at least one common ancestor further comprises each of the first plurality of living persons and the first living person together sharing at least a same first common ancestor.

8. The method of claim 7, wherein the assigning is based at least in part on the same first common ancestor.

9. The method of claim 8, wherein the identifying further comprises identifying a second plurality of living persons that share at least a same second common ancestor with the first living person, wherein the second common ancestor is distinct from the first common ancestor;
and wherein the determining the location further comprises determining locations respectively associated with each of the second plurality of living persons;
and wherein the displaying further comprises displaying on the map at least some of the particular locations respectively associated with each of the second plurality of living persons.

10. The method of claim 9, further comprising:
determining at least one generational value associated with each of the first plurality of living persons and with each of the second plurality of living persons, wherein the assigning is based at least in part on the at least one generational value.

11. The method of claim 10, further comprising:
generating at least one visual identifier, based at least in part on at least one of the at least one generational value, the first common ancestor, or the second common ancestor;
wherein, the displaying on the map further comprises marking the at least some of the particular locations respectively associated with each of the first plurality of living persons or with each of the second plurality of living persons using the generated at least one visual identifier.

12. The method of claim 11, wherein a first visual identifier is associated with the first common ancestor and a second visual identifier is associated with the second common ancestor, wherein the first visual identifier is visually distinct from the second visual identifier.

13. The method of claim 6, further comprising:
generating at least one first visual identifier type based at least in part on the at least one common ancestor,
generating at least one second visual identifier type based at least in part on at least one generational value associated with each of the first plurality of living persons;
wherein, the displaying on the map further comprises marking the at least some of the particular locations respectively associated with each of the first plurality of living persons using the generated at least one first visual identifier type and the generated at least one second visual identifier type.

14. The method of claim 13, further comprising:
generating a symbol that comprises both the generated at least one first visual identifier type and the generated at least one second visual identifier type.

15. The method of claim 3, further comprising:
determining at least one generational value associated with each of the first plurality of living persons, wherein the assigning is based at least in part on the determining the least one generational value.

16. The method of claim 3, further comprising:
generating at least one symbol, wherein each at least one symbol corresponds to each at least one group identifier;
wherein the displaying on the map further comprises marking the at least some of the particular locations respectively associated with each of the first plurality of living persons using the at least one symbol.

17. The method of claim 16, wherein each at least one symbol corresponding to each at least one group identifier is visually distinct from another at least one symbol.

18. The method of claim 2, wherein the identifying further comprises identifying all known living persons that share the first common ancestor with the first living person;
and wherein the determining the location further comprises determining who of the all known living persons have respectively associated known locations;
and wherein the displaying further comprises displaying on the map the known locations respectively associated with the all known living persons.

19. The method of claim 1, wherein the family relationship that the second living person has with the first living person comprises the first living person and the second living person sharing a first common ancestor, the method further comprising:
identifying, based at least in part on the received input, a third living person that at least one of shares the first common ancestor with the first living person and the second living person or shares a second common ancestor with at least one of the first living person or the second living person;
determining a location associated with the third living person; and
displaying on a map the location associated with the third living person.

20. The method of claim 19, wherein the displaying the location associated with the third living person is based at least in part on the second common ancestor.
